(19) United States
(12) Patent Application Publication
(10) Pub. No.: US 2008/0179400 A1
(43) Pub. Date: Jul. 31, 2008

(54) Cleaning element

(75) Inventor: Gunter Jenner, Kuppenheim (DE)

Correspondence Address: THE CULBERTSON GROUP, P.C., 1114 LOST CREEK BLVD., SUITE 420, AUSTIN, TX, 78746, US

(73) Assignee: JFA Jenner Flock-Applikationen

(21) Appl. No.: 11/433,154

(22) Filed: May 12, 2006

(30) Foreign Application Priority Data
Oct. 20, 2005 (DE) 20 2005 016 573.5

(51) Int. Cl. G06K 7/08

(52) U.S. Cl. 235/449

(57) ABSTRACT

The invention relates to a cleaning element for magnetic track and/or chip card and/or optical readers comprising a flat carrier, said carrier being coated with a cleaning material in order to clean reading sensors, said cleaning material being configured as a layer of flock material, and said carrier substantially consisting of a flexible, fleece-like material in order to be used for bank note readers.

The present invention relates to a cleaning element for readers with which data stored are acquired from a magnetic track or a chip card or via optical sensors.

Readers of this kind are known above all for money cards or other cards allocated to a specific user. On these cards, data are stored in specific magnetic strips or in chips and can be read out with the aid of appropriate sensors. A money card to be used in cash machines is a typical example of application.

Moreover, readers are known which additionally or alternatively read out data via optical sensors, too. In the easiest case, this may be a barcode, but more complicated codings which are not easily recognizable to the human eye can be stored and read out, as well.

Readers of this kind have to be cleaned from time to time. For this purpose, a cleaning card and a corresponding method of manufacturing are known from the document WO 98/44449, with this card having a specific cleaning area in several places. When the card is inserted into the reader to be cleaned, this cleaning area contacts the sensors present there and cleans them. This can be promoted by moving the card to and fro. The cleaning areas are flocked with individual fibers which make a good cleaning effect possible with high stability and without damaging the sensitive sensors.

This type of cleaning card has the disadvantage that it has a narrow field of application and is particularly not suitable for devices into which bank notes are introduced and are simultaneously examined optically as to genuineness, for example. The bank notes, which are flexible per se, are thinner than the cards known. Furthermore, the transport paths of the bank notes inside the readers are often not linear and comprise portions of more or less sharp curvature.

It is therefore the object of the invention to provide a cleaning element for bank note readers which overcomes the aforesaid disadvantages and is capable of offering good cleaning properties and of cleaning different sensors within one bank note reader. Furthermore, the object of the invention is to make it possible to also clean the elements transporting the bank notes inside the reader.

This object is achieved with a cleaning element according to claim 1.

The invention is based on the idea that a cleaning element to be used in bank note readers advantageously comprises a flexible, fleece-like carrier. On the one hand, a carrier of this kind makes it possible to flexibly guide the cleaning element inside the bank note reader; on the other hand, the nature of a fleece also allows the cleaning of transport elements, which may be effected simultaneously with the cleaning of the sensors. Analogously, apart from cleaning reading sensors, the cleaning element may of course also be used to clean write heads of the bank note reader used to potentially store data on bank notes.

A most simple embodiment of the cleaning element which can be used for any type of bank note readers (cash machines, gambling machines, money changing machines, etc.) comprises a flat carrier having a top side and a bottom side. In order to clean reading sensors, the carrier is coated with a cleaning material in at least one cleaning area which can be predetermined. The cleaning area is allocated to at least one—as the case may be, several—reading sensor(s) located inside the bank note reader. The cleaning area may be arranged on the top side or on the bottom side of the carrier. If several cleaning areas are provided, they may of course also be provided on both sides of the carrier and may be arranged differently. What is conceivable in particular is the case that, inside the bank note reader, different types of sensors are arranged on different sides of the bank note (or of the cleaning element inserted). In this case, for each sensor, a cleaning area which is specifically arranged for this sensor, respectively, is to be provided on the top side or on the bottom side of the carrier.

The cleaning material of the cleaning areas is configured as a layer of flock material and comprises a multitude of individual fibers. The fibers extend upwardly from the carrier, which is preferably—but not exclusively—effected perpendicularly to the carrier.

According to the invention, the carrier to be used in bank note readers substantially consists of a flexible, fleece-like material. This way of configuring the carrier allows the cleaning element to be flexibly guided inside the bank note reader. Due to the flexibility of the carrier, the cleaning element can also be moved along curved transport paths inside the bank note reader. Thus, the rigid nature of the cards known from prior art is advantageously overcome.

Another advantage is that the fleece itself has a cleaning effect on conveying elements which transport the bank note in the bank note reader. Rollers, pressure rollers etc. of this kind will (automatically) come into contact with the fleece-like material merely by inserting or withdrawing the cleaning element and will be cleaned thereby. Thus, a cleaning element of this kind makes the thorough and extensive cleaning of bank note readers possible in a very easy and advantageous way, particularly in the area of the transport paths of the bank notes and of the reading position or the reading sensors and/or the write heads.

According to another advantageous embodiment of the invention, the fleece-like material of the carrier is configured to be substantially tear-resistant. This will guarantee that the cleaning element is not unintentionally extended in the longitudinal or width directions when it is used inside the bank note reader. Thus, while the cleaning effect of the fleece is maintained unchanged, the tear-resistant embodiment guarantees dimensional stability and, as the case may be, the possibility of repeated use of the cleaning element.

A fleece-like material made of polyethylene has turned out to be particularly advantageous. Even more advantageously, the fleece-like material is Tyvek, which is offered by the company Dupont. This material combines the fleece-like nature with the inherent special cleaning potential on the one hand and an almost foil-like flexibility, which makes the use in bank note readers particularly easy and safe, on the other hand.

In principal, particularly fleece, Tyvek, plastics (PVC) or cloth are eligible as a material for the cleaning element, which, however, does not exclude other suitable materials.

According to a particularly advantageous embodiment of the invention, the cleaning material comprises regular or irregular discontinuities of the coating. Here, a principally coherent cleaning area which is provided on the carrier for cleaning a specific sensor, for example, is traversed by several or a multitude of discontinuities. This means that the substantially coherent cleaning area is separated into a plurality of individual coating sections which are spaced apart from one another by a distance that can be predetermined.

Configuring the coating in this manner has the advantageous effect of cleaning the components to be cleaned, respectively, at intervals. When the cleaning element is moved in the longitudinal direction, the fibers of an individual coating section are moved towards and touch the components to be cleaned (magnetic reading head, optical lens, chip contacts, etc.) and are led past these components until the coating section is terminated by a discontinuity of the coating. When the cleaning element is moved farther, the fibers of the adjacent next coating section are again moved towards and touch the components to be cleaned, so, as a whole, the fibers of the coherent cleaning area are brought into contact with the components to be cleaned at individual intervals. As the fibers of the individual coating sections act upon the components to be cleaned at intervals or abruptly, better cleaning is effected than with a continuously flocked cleaning layer.

The fibers of the individual coating sections which are separated from each other by discontinuities are more easily and individually movable than those of a continuous or homogeneous cleaning coating. The fact that the components to be cleaned are acted upon abruptly, e.g. by fibers of an individual coating section springing to and fro, results in more thorough cleaning as a whole.

If individual components or sensors to be cleaned are arranged in depressions inside the reader, the regularly discontinuous cleaning layer causes the periodical jerking of the fibers into the recess and a correspondingly periodical cleaning action upon the sensor which is arranged in the depression. This contact at intervals has the effect of clearly better cleaning as compared to the case in which a homogeneous, continuous coating area is used.

The discontinuities may have regular or irregular shapes and may depend on a suitable manufacturing method. What is conceivable in particular is the configuration of geometrically regular shapes of the individual coating sections (triangular, square, rhombic, circular, etc.), with these sections being separated from one another by recesses or discontinuities in the coating arranged between them correspondingly.

In order to meet the cleaning requirements of different sensors, respectively, an advantageous embodiment of the invention consist in that the fibers of different cleaning areas (or the fibers of individual coating sections within a coherent cleaning area) may be configured differently. Advantageously, variations regarding the density of the arrangement, the length, the diameter or the orientation of the fibers relative to the carrier are possible. It is conceivable, for example, to act upon a first sensor with relatively long and densely arranged fibers, whereas another sensor is to be cleaned with individual short, thick fibers which are spaced apart at a lager distance from one another.

In particular, it may also be appropriate to choose a different orientation or inclination of the individual fibers relative to the carrier for the different coating sections or cleaning areas. A substantially perpendicular arrangement of the fiber on the carrier ensures that a movement of the carrier in its two main directions (which determine the substantially flat shape of the carrier) results in approximately the same cleaning effect. Contrasting to this, fibers may also be arranged on the carrier in such a way that they are preferably inclined in a specific direction. In this case, the fibers provide a different cleaning resistance depending on their direction of movement. If the direction of movement forms an angle of less than 90° with the inclined fiber, the resistance against a movement in this direction is higher than in the case in which the angle included is larger than 90°. Accordingly, the cleaning power can be made conditional on the direction of movement and thus allows a flexible use of the cleaning element depending on the cleaning requirements.

As mentioned, an orientation of fibers of this kind can be chosen uniformly for all fibers of a coherent cleaning area. It is also conceivable, however, to choose different orientations of the fibers in the individual coating sections even for one coherent cleaning area. For example, fibers of different coating sections which are directed towards one another at an angle provide a higher cleaning resistance sometimes in one direction of movement and sometimes in the other direction of movement, respectively, so, when the cleaning element is moved to and fro, a better cleaning effect is achieved as a whole compared to the case in which all fibers extend perpendicularly from the carrier and clean irrespective of the direction.

For the use of the cleaning element, a gripping section is advantageously provided at which the cleaning element may be introduced into the bank note reader.

Furthermore, it is intended to provide at least one marking area on the cleaning element so as to add optical indications there. These may include indications of the manufacturer or indications relating to the use which can provide the user with corresponding information.

Moreover, the cleaning element is advantageously configured such that the cleaning material and/or the carrier can be soaked with a cleaning liquid. A liquid of this kind, which may particularly be applied immediately before it is used for cleaning, increases the cleaning effect. Depending on the nature or the absorbency of the fleece-like carrier material, the amount of cleaning liquid that can be absorbed is high or can be chosen. This will help to optimize the cleaning operation.

It is to be pointed out explicitly that the cleaning element may also comprise at least one cleaning area which is intended for a magnetic reading head or a chip capable of being read out. This has particularly the purpose that corresponding bank note readers which comprise sensors of this kind can be cleaned. Although the use of magnetic strips or memory chips that can be read out on bank notes is currently not state of the art yet, the cleaning element is to be explicitly configured for cleaning sensors of this kind inside bank note readers, too.

According to another advantageous embodiment of the invention, at least one area for storing data is provided on the cleaning element so that data can be stored in this area or can be read out from this area. These data may embody various contents and may particularly be interdependent on the reader into which the cleaning element is to be inserted. The data storage area may be arranged at an arbitrary place on the cleaning element. Data may be read out or stored at arbitrary times, but particularly in the state in which the cleaning element is inserted in the reader.

According to another advantageous embodiment, the data storage area is configured in the form of a magnetic strip. Magnetic strips are per se known from prior art and make it possible to store data in an easy way. Furthermore, the magnetic strip is relatively flat, so the thickness of the cleaning element is not increased at all or only to a negligible extent.

According to another advantageous embodiment of the invention, the at least one magnetic strip is arranged on the edge portion of the cleaning element. Particularly in those cases in which the cleaning element is introduced into the reader with its small side ahead, the obvious thing to do is to arrange the magnetic strip on the edge of this small side. In this way, data can be read out or stored without the necessity of fully introducing the cleaning element into a reader, for example.

A particularly advantageous development of this idea consists in providing the magnetic strip which is arranged on the edge with access information or an access code which can be checked when the element is introduced into the reader. Thus, it is possible, for example, to ensure that the reader only opens an inlet slot and allows the use of the cleaning element if a specific coding of the magnetic strip exist. In case of an incorrect coding, the non-opening slot blocks the insertion of the cleaning element. Appropriately, a reading unit cooperates with the magnetic strip arranged on the edge, which reading unit is located on the reader directly adjacent the inlet slot and can thus read out the data even before the cleaning element would partly or even completely have to be introduced into the reader.

Thus, if the storage area or the magnetic strip is arranged directly on the edge of the cleaning element, it is possible to ensure that a corresponding opening slot will only be unblocked for introducing the element if the data stored on the element are already checked by corresponding reading mechanisms immediately before the element is introduced so as to open the inlet slot.

As shown above, an embodiment of the cleaning element is conceivable in which this element does not have to be completely introduced into the reader. As an alternative, however, an embodiment of the cleaning element may also be configured which absolutely requires that the element is completely introduced into the reader. What is conceivable here is an embodiment in which the cleaning element comprises one magnetic strip as a storage area on the front edge and on the rear edge (in the direction of insertion), respectively. The associated reader is capable of checking whether the card has been inserted completely, i.e. whether both storage areas can be read out by correspondingly arranged reading elements or can be checked with respect to the contents stored. If the card has not been introduced completely or the correspondingly arranged data area is missing or contains wrong data, either further use of the card may be terminated or the card may be expelled. What is also conceivable is that the element is transported inside the reader to a collecting portion for defective cleaning elements or cards. This will make it possible to ensure that only complete cleaning elements and cleaning elements which are permissible for the respective purpose are introduced into the reader.

The cleaning element according to the invention is principally adapted to be suitable for all readers into which means of payment (bank notes, cards, coupons) can be introduced. Readers on platforms, for flight tickets or for ships etc. are to be taken into consideration, too, so the cleaning element according to the invention is to be provided for devices of this kind, too.

Further advantageous embodiments are apparent from the subclaims.

An embodiment of the invention is explained below with the aid of an example in the Figures. In the Figures,

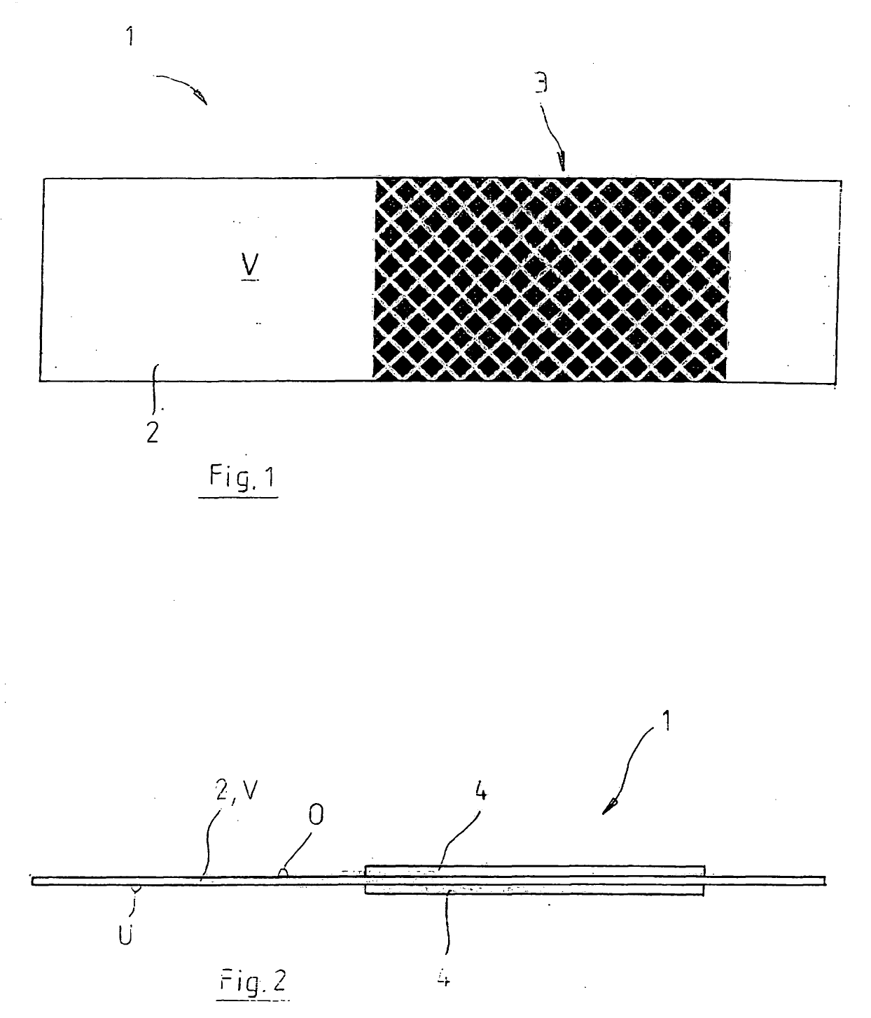

FIG. 1 shows a schematic top view of a first embodiment of the cleaning element,

FIG. 2 shows a schematic side view according to FIG. 1,

FIG. 3 shows a schematic top view of a developed form of the cleaning element, and

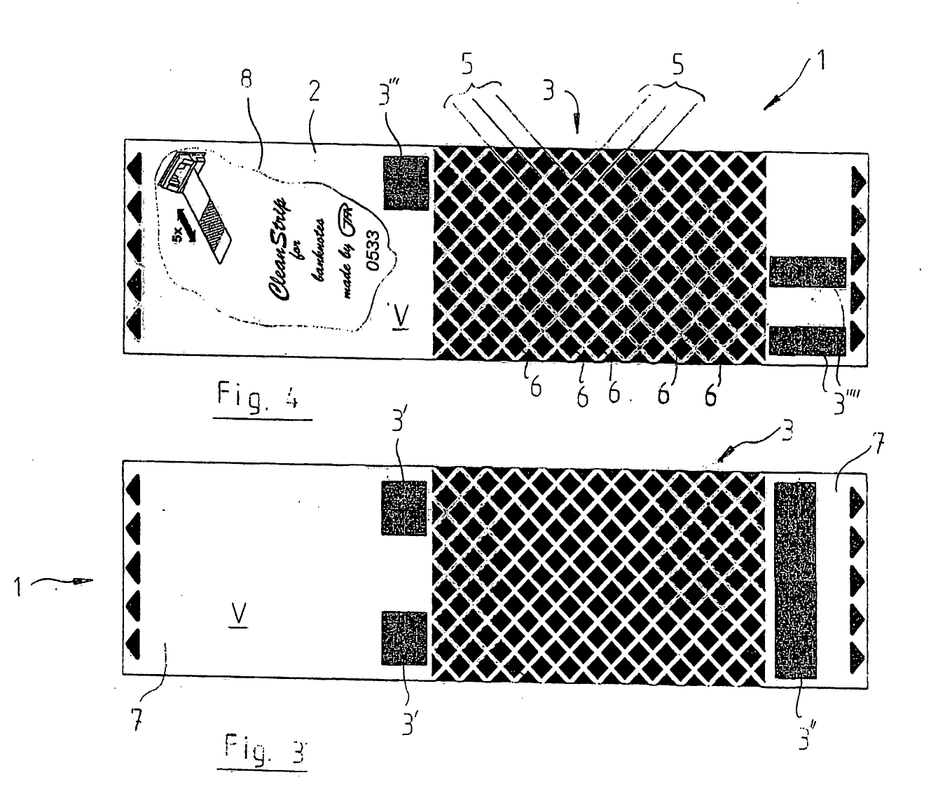

FIG. 4 shows a schematic top view of another embodiment of a cleaning element according to the invention, and

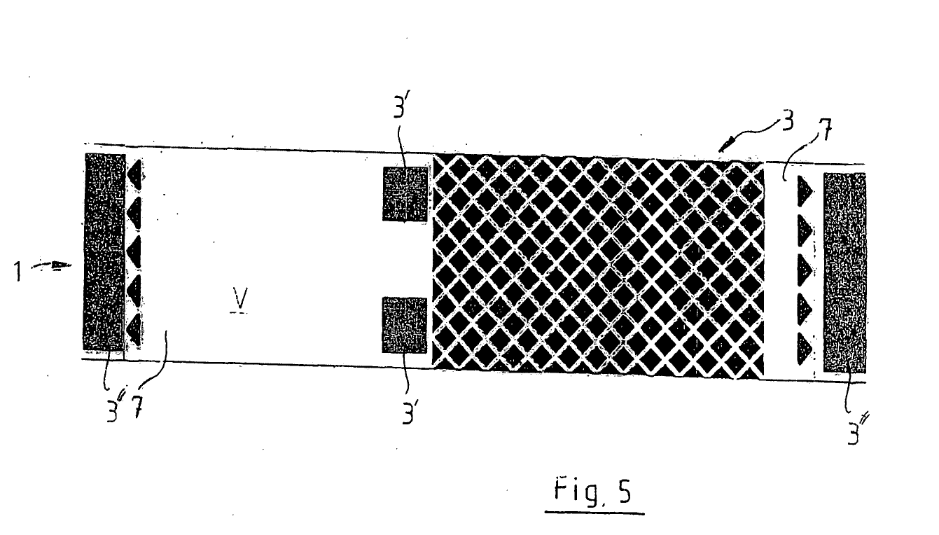

FIG. 5 shows a slightly amended form of a cleaning element as compared to the one in FIG. 3.

In FIG. 1, a cleaning element 1 is shown which is substantially formed by a flat carrier 2. The carrier 2 consists of a fleece-like material V. A cleaning area 3 extends over the entire width of the carrier 2 and serves to clean at least one sensor inside a bank note reader.

As is apparent from the side view in FIG. 2, two cleaning areas are altogether provided, which are realized by a cleaning material 4 in the form of a layer of flock material, respectively. Thus, one cleaning area, respectively, which is coated with a cleaning material 4, is located on the top side O and on the bottom side U of the carrier 2. This makes it possible to clean sensors or write heads which are arranged in the reader on both sides of the bank note.

FIG. 3 shows a development of the cleaning element 1. What is again apparent is a first cleaning area 3, with second cleaning areas 3′ and a third cleaning area 3″ being provided adjacent thereto. Each cleaning area 3, 3′, 3″ serves to clean one or several special sensors inside a bank note reader. The cleaning material in each of the aforesaid cleaning areas may be chosen to be identical or different, depending on the cleaning requirements of the respective sensor.

On both ends of the carrier of the cleaning element which is formed to be a fleece V, two gripping sections 7 are provided so as to make it easier for the user to handle the carrier.

In the illustration of FIG. 4, one can see that discontinuities 5 of the coating are provided in the first cleaning area 3. These discontinuities 5 run through the coating like a cruciform lattice, whereby individual coating sections 6 are formed which have a substantially square area. When the cleaning element is used, this results in the fact that at least the sensor for which the cleaning area 3 is intended is acted upon at intervals. Of course, a corresponding discontinuity of the other cleaning areas (3′, 3″, 3′″ etc.) is conceivable, too, if this makes sense with respect to cleaning.

Furthermore, in the portion of the carrier 2 which is not coated for the purpose of cleaning sensors, a marking area 8 is provided on which information for the use of the cleaning element, information from or about the manufacturer or other indications may be provided.

The illustration in FIG. 4 may also show the bottom side of FIG. 3, so FIGS. 3 and 4 as a whole show one and the same cleaning element from two different sides. What is also visible is that a further cleaning area 3′″ is provided in FIG. 4, which is again allocated to a specific sensor.

FIG. 5 shows a slightly amended form of a cleaning element as compared to the one in FIG. 3. What is visible there are two magnetic strips 3″ directly on the front edge and on the rear edge of the cleaning element 1. An arrangement of this kind ensures that the data stored in the magnetic strips 3″ are scanned and checked immediately when the cleaning element is introduced into the reader, potentially even before a closing mechanism opens a corresponding inlet slot. The two magnetic strips 3″ may furthermore be used to check whether the insertion position of the cleaning element in the reader has been assumed completely and correctly. For example, this position may be deemed to have not been assumed until the cleaning element has been drawn into the reader to such an extent that the magnetic strip arranged on the other end has traveled far enough into the reader e.g. in such a way that the data thereof can be checked. This will particularly ensure that the cleaning element has been introduced completely since otherwise the second magnetic strip or the data thereof do not reach the associated reading area.

1. A cleaning element (1) for magnetic track and/or chip card and/or optical readers, comprising
a) a flat carrier (2) having a top side (O) and a bottom side (U),
b) said carrier (2) being coated with a cleaning material (4) in at least one cleaning area (3, 3′, 3″, 3′″, 3″″) which can be predetermined in order to clean reading sensors,
c) said cleaning area (3, 3′, 3″, 3′″, 3″″) being arranged on the top and/or bottom side (O, U) of said carrier, and
d) said cleaning material (4) being configured as a layer of flock material which comprises a multitude of individual fibers which extend from the carrier (2),
characterized in that
c) said carrier (2) substantially consists of a flexible, fleece-like material (V) in order to be used for bank note readers.

2. A cleaning element according to claim 1, characterized in that said fleece-like material is configured to be substantially tear-resistant.

3. A cleaning element according to one of the preceding claims, characterized in that said fleece-like material is polyethylene.

4. A cleaning element according to one of the preceding claims, characterized in that said fleece-like material is Tyvek®.

5. A cleaning element according to one of the preceding claims, characterized in that, in order to effect cleaning at intervals, the coating with cleaning material (4) has regular or irregular discontinuities (5) of the coating in at least one coherent cleaning area (3, 3′, 3″, 3′″, 3″″).

6. A cleaning element according to the preceding claim, characterized in that said discontinuities (5) of the coating are formed by a distance to be predetermined between individual coating sections (6), said coating sections (6) preferably having regular geometric shapes.

7. A cleaning element according to one of the preceding claims, characterized in that said fibers
a) of different cleaning areas (3, 3′, 3″, 3′″, 3″″) or
b) of individual coating sections (6) within a coherent cleaning area (3, 3′, 3″, 3′″, 3″″)
are configured to be different as far as the density of their arrangement and/or their length and/or their diameter and/or their orientation relative to the carrier (2) are concerned.

8. A cleaning element according to one of the preceding claims, characterized in that, for each type of reading sensor within a bank note reader, a cleaning area (3, 3′, 3″, 3′″, 3″″) that is allocated to this sensor is provided on the carrier.

9. A cleaning element according to one of the preceding claims, characterized in that that at least one gripping section (7) is provided on the carrier so that the cleaning element can be introduced into the bank note reader.

10. A cleaning element according to one of the preceeding claims, characterized in that at least one marking area (8) is provided on the carrier for optical indications.

11. A cleaning element according to one of the preceding claims, characterized in that said cleaning material and/or said carrier can be soaked with a cleaning liquid.

12. A cleaning element according to one of the preceding claims, characterized in that said cleaning material comprises at least one data storage area which is adapted for storing and reading out constant or variable data.

13. A cleaning element according to the preceding claim, characterized in that said at least one data storage area is configured in the form of a magnetic strip.

14. A cleaning element according to the preceding claim, characterized in that said magnetic strip is arranged on the edge, preferably on the edge of the small side of the cleaning element.

15. A cleaning element according to the preceding claim, characterized in that the magnetic strip or strips arranged on the edge are adapted for storing data with which the authorization to introduce a cleaning element into a reader and/or the assumption of an insertion position inside the reader which can be predetermined can be encoded and checked.
